(19) United States
(12) Patent Application Publication
(10) Pub. No.: US 2007/0170836 A1
(43) Pub. Date: Jul. 26, 2007

(54) Production of flat dielectric barrier discharge lamps

(76) Inventor: Ahmet Oran, Giengen (DE)

Correspondence Address: OSRAM SYLVANIA INC, 100 ENDICOTT STREET, DANVERS, MA, 01923, US

(21) Appl. No.: 11/657,062

(22) Filed: Jan. 24, 2007

(30) Foreign Application Priority Data
Jan. 26, 2006 (DE) 10 2006 003 828.2

(51) Int. Cl. H01J 1/62

(52) U.S. Cl. 313/493

(57) ABSTRACT

The invention relates to the production of dielectric barrier discharge lamps with a flat discharge vessel. At least one material recess (5), for example a groove, is provided in at least one discharge vessel part (1). During the joining of the discharge vessels in a vacuum oven, at least pressure equalization or else evacuation, purging and filling steps can be carried out through the material recess or recesses. This makes it possible to avoid stresses and, in particular when a plurality of discharge vessels which are stacked one on top of the other are being joined, to achieve standard gas purity in the completely joined discharge vessels. The material recesses (5) are closed by glass solder (8) once the lamp has been completely joined together.

### TECHNICAL FIELD

This invention relates to the production of dielectric barrier discharge lamps with flat discharge vessels

### BACKGROUND ART

Dielectric barrier discharge lamps (which are also referred to as “silent discharge lamps”) are known per se. This lamp type has the characteristic that at least the anodes, and frequently all the electrodes as well, are separated by a dielectric layer, that is to say a “barrier” from the gaseous discharge medium in the discharge vessel. Dielectric barrier discharge lamps such as these can be produced with various geometries. In addition to other technical characteristics, they are also of interest because of the good capability to produce flat discharge vessel shapes, particularly for back-lighting of display screens, monitors, display devices and the like, as well as for general illumination.

Flat discharge vessels such as these for dielectric barrier discharge lamps normally comprise a base plate and a cover plate, between which a frame can be located, although this frame need not necessarily be provided. In fact, at least one of the two plates can also be shaped such that the two together enclose a discharge area even without a frame. In this context, reference should be made for example to U.S. Pat. No. 6,657,392 B2. The expression “flat” in this case means that the area extent of the discharge vessel, that is to say the edge lengths of the plates, is considerably larger than the thickness of the discharge vessel at right angles to it.

The flat discharge vessel must be “joined”, that is to say initially separate discharge vessel parts must be connected to one another, and this is generally done by the melting of glass solder in an oven. The discharge area which is connected by the discharge vessel must have impurities removed from it, for example binder residues which result from the glass solder during heating, removed from it, and must be evacuated and filled with the discharge medium, before finally being closed.

In this case, one process step comprises the discharge vessel being completely closed, in a sealed manner, after being filled with the discharge medium. The prior art, for example U.S. Pat. No. 6,659,828 B1, teaches inter alia the spacers which are provided in any case for robustness reasons between the base plate and the cover plate being placed on glass-solder “cushions”, and the cover plate thus being held at such a height that a gap remains between the cover plate and the frame. Above a specific temperature, the cover plate is then lowered onto the frame by softening of the glass solder cushion and corresponding lowering of the spacers, and is in turn connected thereto by the softened glass solder. As an alternative to this, it is also known from U.S. Pat. No. 6,976,896 B2 for the cover plate to be held up by glass solder cushions between the cover plate and the frame, and to be lowered by softening.

### DISCLOSURE OF THE INVENTION

The present invention is based on the technical problem of specifying a production method, which is advantageous in terms of a need to close the discharge vessel, for dielectric barrier discharge lamps with a flat discharge vessel, as well as a correspondingly produced discharge lamp.

The invention relates to a method for production of a dielectric barrier discharge lamp having a flat discharge vessel, in which a cover plate and a base plate are optionally connected to an additional frame arranged in between them, and these discharge vessel parts are connected by melting of glass solder, whereby at least one discharge vessel part has at least one material recess before the connection of all of the discharge vessel parts, the material recess remains during the connection process as access to the interior of the discharge vessel, and, after the connection process, glass solder runs into the material recess, by heating the discharge vessel in an oven, and closes this material recess and thus the discharge vessel.

Preferred refinements will be explained in more detail in the following text. Features disclosed in this case as well as in the exemplary embodiment are significant not only with respect to the method aspect but also with respect to the apparatus aspect without any distinction being explicitly drawn between them in detail here.

In the most general sense, the invention is based on a connection of a cover plate and of a base plate by melting of glass solder. In this case, a frame can optionally be provided between the cover plate and the base plate. However, at least one of the two plates is preferably shaped along its circumferential edge area such that it carries out the function of a frame, so that in consequence there is no need for a separate frame. For further details, reference should be made by way of example to U.S. Pat. No. 6,657,392 B2, which has already been mentioned in the introduction.

In contrast to the prior art, however, at least one of the discharge vessel parts has at least one material recess before the connection of all the discharge vessel parts, for example in a corner, for example in the form of a groove which leads from the interior of the discharge vessel to the outside. This material recess still exists once the discharge vessel parts have been connected, and is used for access to the discharge area, that is to say for pressure equalization or for filling with the discharge medium and, if required, for previous evacuation, purging and the like. The material recess, and thus the discharge vessel, are then closed according to the invention by softened glass solder flowing into the material recess. For this purpose, the discharge vessel is heated to an adequate temperature in an oven in which any previous evacuation and purging steps, and in each case the filling with the discharge medium, are carried out. The glass solder is in this case intended to flow into the material recess by gravitation and/or capillary forces, preferably by gravitation forces, that is to say downwards from the top.

In contrast to the prior art, this process can be carried out in such a way that closure does not take place until the glass solder has become relatively liquid and not just viscously deformable. Since specific minimum temperatures are required for the joining of the discharge vessel, the described procedure according to the prior art is subject to the problem that the glass solder cushions become soft even at temperatures which are lower than the maximum discharge vessel temperature, thus becoming soft at an earlier time, so that the already closed discharge vessel is heated even further. This results on the one hand in a thermally dependent rise in the internal pressure and thus in the need to likewise raise the oven pressure. Secondly, as the inventor has observed, stresses can occur and can be “frozen” in the lamp, and this can lead to increased scrap or failure rates.

These difficulties can be avoided with the invention, because the glass solder cannot flow adequately, thus closing the material recess, until a temperature is reached, and thus not until a time at which sealed joints are also produced by the glass solder at the same time. There is no therefore no longer any need for any further significant temperature increase.

Regardless of this, the invention may, however, also be advantageous for other reasons, for example in order to make it possible to dispense with the glass solder cushions that have been mentioned.

The method according to the invention is particularly advantageous in the case of discharge vessels without separate frames, since the material recess provided according to the invention can intrinsically be produced in the shapes that are required in any case for at least one of the two plates, for example by also producing a groove which runs to the exterior in the edge area of the plate, for example in the vicinity of a corner, during the process of deep-drawing of a plate.

Two diagonally arranged material recesses are preferably provided, particularly preferably four material recesses, that is to say one at each corner. A total of four material recesses improves the accessibility to the discharge area for pumping and filling, without making the method according to the invention significantly more complicated.

The glass solder which is intended to close the material recesses according to the invention is, for example, arranged in the form of a glass solder blob or glass solder molding in an area above the material recesses. This has the advantage that, in addition to the capillary forces, gravitation additionally assists the flowing of the glass solder, which has been softened by heating, during the closing process. Alternatively, glass solder blobs or glass solder moldings can also be dispensed with if the circumferential edge area of the plate is provided with sufficient glass solder paste. This even has the advantage that this prevents outward swelling, as may occur in the case of glass solder moldings. Furthermore, this avoids the creation of raised points resulting from non-uniformly distributed glass solder moldings during the closure process. The discharge area is then pumped out and purged only through the material recess or recesses that have been mentioned. In any case, the material recess is preferably in the form of a groove with a V-shaped profile for this purpose. The process according to the invention can thus preferably be carried out in such a way that, on reaching the appropriate temperature, that is to say after the closure of the discharge vessel, there is no further additional significant temperature increase and it is thus possible to avoid the need for compensation for an internal pressure rise in the lamp, and to avoid stresses in the lamp. However, this process control is not essential since the invention, as stated in the introduction, can also be chosen and carried out appropriately with regard to other advantages.

### BRIEF DESCRIPTION OF THE DRAWINGS

The invention will be explained in more detail in the following text with reference to one exemplary embodiment. In the figures:

FIG. 1 shows a schematic plan view of a base plate for a dielectric barrier discharge lamp as a starting point for the production method according to the invention,

FIG. 2a shows a schematic side view in order to illustrate the position of the discharge vessel parts before closure, and

FIG. 2b shows a schematic side view of the completely closed discharge vessel.

### BEST MODE FOR CARRYING OUT THE INVENTION

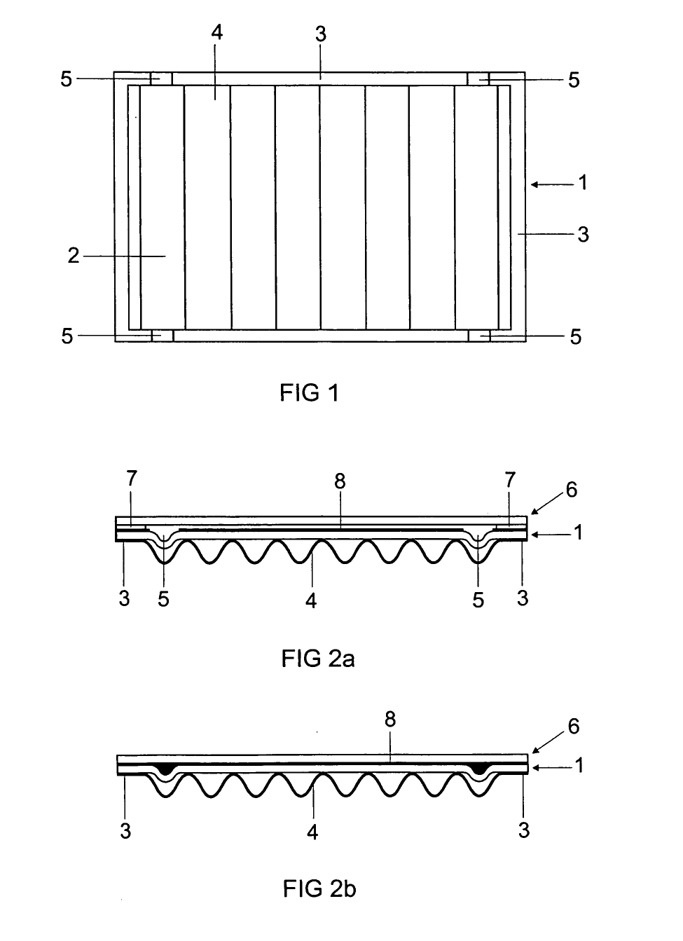

FIG. 1 shows a schematic plan view of a cover plate 1 composed of glass for a dielectric barrier discharge lamp which can be produced according to the invention. The cover plate 1 has a corrugated area 2 as well as an edge area 3, which surrounds it in the form of a frame and is essentially planar. The waves 4 in the corrugated area 2 are formed in such a manner that on the one hand they are raised above a plane which is defined by the planar edge area 3, for example by deep-drawing of an initially planar glass plate. This can be seen particularly well in the side views illustrated in FIGS. 2a, 2b, and which are explained in even more detail further below. A groove 5 is formed in each of the areas of the four corners of the frame-like edge area 3, preferably actually during the deep-drawing of the glass plate, at the same time as the waves 4. The grooves 5 extend at right angles to the edge area 3 and each open into a “wave peak” which, once the lamp has been completely joined together, form one of a plurality of elongated discharge areas, which follow one another, parallel. The grooves 5 are thus used as pumping openings for pumping out, purging and finally filling of the joined discharge vessel, and if required for pressure equalization. In the final phase of the production process, the grooves are closed by means of glass solder. In order to make it easier for the glass solder to flow in, the grooves 5 have an essentially V-shaped profile. This will be explained in more detail in the following text with reference to FIGS. 2a and 2b and in conjunction with the joining of the cover plate 1 to the base plate 6.

For joining purposes, the cover plate 1 is inserted into a joining chamber, for example composed of V2A perforated sheet, although this is not illustrated, for the sake of simplicity, in the schematic side view shown in FIG. 2a. The bottom of the joining chamber is formed by a Robax glass plate. The cover plate 1 is oriented such that the “wave peaks” 4 point downwards, that is to say in the direction of the bottom of the joining chamber, and in consequence the grooves 5 are opened at the top. The essentially planar base plate 6 is placed thereon, and is provided with glass solder blobs 7, facing the cover plate 1, in each of its corner areas. Until the softening temperature is reached, the glass solder blobs 7 act as spacers between the base plate and bottom plate, and create a pumping gap during this period. Alternatively, for example, a glass solder tablet can in each case be provided as well in the center of each edge side, between the two plates. In addition, a dispensed glass solder edge 8 can be seen. This glass solder edge 8 is made solid by drying and is used later for gas-type connection of the cover plate 1 and base plate 6. Provided that this glass solder edge 8 has been applied with sufficient thickness, it is alternatively also possible to dispense with glass solder blobs or tablets. In this form, the discharge vessel, which has been assembled but has not yet been joined, evacuated and filled, can be introduced into a vacuum oven in which it is filled with a neon-xenon gas mixture at about 310 mbar after appropriate evacuation and purging steps, at about 440° C. The discharge vessel is still open at this temperature and this pressure. The glass solder tablets 7 still hold the base plate 6 above the cover plate 1, so that not only the grooves 5 but also a circumferential gap between the frame-like edge area 3 of the cover plate 1 and the base plate 6 also remain free. On reaching a temperature of about 500° C., at which the glass solder softens, but is still relatively viscous, the base plate 6 is first of all lowered onto the cover plate 1, with the grooves 5 still remaining open and thus ensuring pressure equalization. Once the melting temperature of the glass solder has been reached at about 550° C., the grooves 5 are closed by the glass solder tablets 7 flowing out into the grooves as a consequence of gravitation. The capillary effect and wetting characteristics provide further assistance during this process, thus resulting in an effectively sealed joint. During this process, the joining chamber holds the described plate stack together.

For financial reasons, the discharge vessel parts which have been correspondingly assembled in pairs of two or more, for example three, discharge vessels are preferably stacked one on top of the other in the joining chamber. The particular advantage of the grooves in this case is that they result in all of the lamps being completely closed at the same time—irrespective of the position in the stack—specifically when the glass solder tablets have reached the melting temperature, and the glass solder flows into the grooves and thus finally closes them. This ensures uniform gas purity in all of the discharge vessels in the stack, and avoids stresses being “frozen in”. This is because, without the grooves according to the invention, the lowermost pair of plates would be closed first of all when the glass solder tablets became soft, because the greatest weight acts on them, followed by the next and so on until the closure of the uppermost pair of plates. This would result in different gas purities as well as stresses in the vessels.

Finally, FIG. 2b shows the completely joined together lamp. In this case, the material of the solder tablets 7 has closed the grooves 5 in a gas-tight manner. In addition to the frame-like edge area 3, the waves 4 also support the cover plate 1, as shown in FIG. 1, and the base plate 6 with respect to one another in order to prevent mechanical damage resulting from the reduced pressure in the discharge vessel, or resulting from bending loads.

Although the invention has been explained in more detail using the example of a flat discharge vessel with a corrugated cover plate, it is not restricted to this embodiment. In fact, its advantageous effect is also achieved in the production of flat discharge vessels with differently shaped cover or base plates, for example with shapes other than the corrugated shape illustrated, and with completely flat plates and a separate edge.

The electrode and contact structures are not illustrated in the drawings, since they are not of any more interest here. In principle, they can be applied to the inside or outside of the discharge vessel, for example by means of screen printing, to be precise before or after the closure of the discharge vessel.

1. A method for production of a dielectric barrier discharge lamp having a flat discharge vessel, in which a cover plate and a base plate are optionally connected to an additional frame arranged in between them,
and these discharge vessel parts are connected by melting of glass solder,
whereby
at least one discharge vessel part has at least one material recess before the connection of all of the discharge vessel parts,
the material recess remains during the connection process as access to the interior of the discharge vessel,
and, after the connection process, glass solder runs into the material recess, by heating the discharge vessel in an oven, and closes this material recess and thus the discharge vessel.

2. The method as claimed in claim 1, with the material recess being in the form of a groove.

3. The method as claimed in claim 2, with the groove having an essentially V-shaped profile.

4. The method as claimed in claim 2, with the groove being formed by deep drawing in the base plate or cover plate.

5. The method as claimed in claim 1, with two material recesses being arranged diagonally in the corner areas of a discharge vessel part.

6. The method as claimed in claim 1, with one material recess in each case being arranged in each of the four corner areas of a discharge vessel part.

7. The method as claimed in claim 1, in which, before the connection of the discharge vessel parts, glass solder is arranged at a point which will be positioned at least in the vicinity of the material recess after the connection process.

8. The method as claimed in claim 1, in which, before the connection of the discharge vessel parts, glass solder is applied in the connection area.

9. The method as claimed in claim 1, in which the discharge vessel parts are joined together and the discharge vessel is subsequently heated in a joining chamber which surrounds the base plate and the cover plate, fitting them.

10. The method as claimed in claim 1, in which there is no further significant temperature increase after the material recess or recesses has or have been closed.

11. The method as claimed in claim 9, with the discharge vessel parts for two or more discharge vessels being joined together successively and being stacked one on top of the other in the joining chamber.

12. A dielectric barrier discharge line having a flat discharge vessel, produced using a method as claimed in claim 1, which has at least one base plate and one cover plate with at least one material recess in at least one of the discharge vessel parts being closed by glass solder which is melted and solidified again.

13. The method as claimed in claim 2, with two material recesses being arranged diagonally in the corner areas of a discharge vessel part.

14. The method as claimed in claim 2, with one material recess in each case being arranged in each of the four corner areas of a discharge vessel part.

15. The method as claimed in claim 2, in which, before the connection of the discharge vessel parts, glass solder is arranged at a point which will be positioned at least in the vicinity of the material recess after the connection process.

16. The method as claimed in claim 2, in which, before the connection of the discharge vessel parts, glass solder is applied in the connection area.

17. The method as claimed in claim 10, with the discharge vessel parts for two or more discharge vessels being joined together successively and being stacked one on top of the other in the joining chamber.
